(19) United States
(12) Patent Application Publication
(10) Pub. No.: US 2022/0147627 A1
(43) Pub. Date: May 12, 2022

(54) DISTRIBUTION SYSTEM, DISTRIBUTION METHOD, AND NON-TRANSITORY COMPUTER-READABLE MEDIUM

(71) Applicant: Yuuki OGAWA, Tokyo (JP)

(72) Inventor: Yuuki OGAWA, Tokyo (JP)

(73) Assignee: Ricoh Company, Ltd.

(21) Appl. No.: 17/510,401

(22) Filed: Oct. 26, 2021

(30) Foreign Application Priority Data
Nov. 10, 2020 (JP) 2020-187282

(51) Int. Cl. G06F 21/55; G06F 21/62; G06F 21/60

(52) U.S. Cl. CPC G06F 21/556; G06F 2221/2141; G06F 21/606; G06F 21/6227

(57) ABSTRACT

A distribution system includes circuitry to analyze distribution data registered with the distribution system and bibliographic information of the distribution data at a predetermined time, to generate security information of the distribution data, to monitor use of the distribution data and to determine whether to permit the use of the distribution data based on the security information of the distribution data.

### CROSS-REFERENCE TO RELATED APPLICATION

This patent application is based on and claims priority pursuant to 35 U.S.C. § 119(a) to Japanese Patent Application No. 2020-187282, riled on Nov. 10, 2020, in the Japan Patent Office, the entire disclosure of which is hereby incorporated by reference.

### BACKGROUND

### Technical Field

Embodiments of the present disclosure relate to a distribution system, a distribution method, and a non-transitory computer-readable medium storing instructions for executing a distribution method.

### Related Art

In recent years, with an increase in security consciousness, there is an increasing demand for prevention of leakage of distribution data in a distribution system that distributes the distribution data such as image data or document data.

There is a known technique in which history information including information on image data and security information of the image data is stored in an information processing device implemented in, for example, image forming apparatus when data corresponding to the image data is input or output, and output of the history information is limited according to the security information.

### SUMMARY

An exemplary embodiment of the present disclosure includes a distribution system including circuitry to analyze distribution data registered with the distribution system and bibliographic information of the distribution data at a predetermined time, to generate security information of the distribution data, to monitor use of the distribution data and to determine whether to permit the use of the distribution data based on the security information of the distribution data.

An exemplary embodiment of the present disclosure includes a distribution method including analyzing distribution data registered with a distribution system and bibliographic information of the distribution data at a predetermined time, generating security information based on the distribution data, monitoring use of the distribution data, and determining whether to permit the use of the distribution data based on the security information.

An exemplary embodiment of the present disclosure includes a non-transitory recording medium storing a plurality of instructions which, when executed by one or more processors, cause the processors to perform a method. The method includes analyzing distribution data registered with a distribution system and bibliographic information of the distribution data at a predetermined time, generating security information based on the distribution data, monitoring use of the distribution data, and determining whether to permit the use of the distribution data based on the security information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of an information processing system according to one of the embodiments of the present disclosure:

FIG. 2 is a block diagram illustrating an example of a hardware configuration of a computer according to the one of the embodiments of the present disclosure;

FIG. 3 is a block diagram illustrating an example of a hardware configuration of an image forming apparatus according to the one of the embodiments of the present disclosure;

FIG. 4 is a block diagram illustrating an example of a functional configuration of a distribution system, according to the one of the embodiments of the present disclosure;

FIG. 5A to FIG. 5C are tables each illustrating an example of information managed by the distribution system according to according to the one of the embodiments of the present disclosure;

FIG. 6A and FIG. 6B are block diagrams illustrating examples of functional configurations of a registration terminal and a user terminal, respectively, according to the one of the embodiments of the disclosure;

FIG. 7 is a sequence diagram illustrating an example of a distribution data registration process according to the one of the embodiments of the disclosure;

FIG. 8 is a table illustrating an example of security information according to the one of the embodiments of the disclosure:

FIG. 9 is a sequence diagram illustrating another example of the distribution data registration process according to the one of the embodiments of the disclosure:

FIG. 10 is a sequence diagram illustrating an example of a process of using the distribution data according to the one of the embodiments of the disclosure;

FIG. 11 is a flowchart illustrating an example of a process performed by a use monitoring unit according to the one of the embodiments of the disclosure;

FIG. 12 is a flowchart illustrating an example of a process performed by a generating unit according to a first embodiment of the disclosure:

FIG. 13 is a table illustrating an example of association information according to the first embodiment of the disclosure; and

FIG. 14 is a flowchart illustrating an example of a process performed by a generating unit according to a second embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a description is given of one of the embodiments of the present disclosure with reference to the attached drawings.

System Configuration:

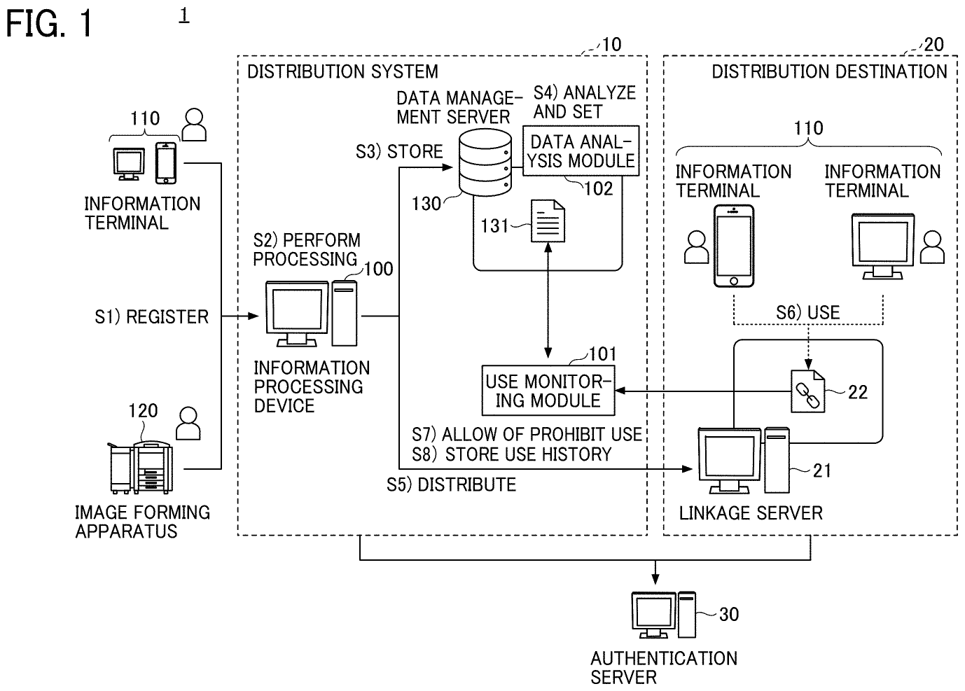

FIG. 1 is a diagram illustrating an example of a system configuration of an information processing system according to an embodiment of the present disclosure. The information processing system 1 includes a distribution system 10, a distribution destination 20, an authentication server 30, an information terminal 110, and an image forming apparatus 120, which are connected to a communication network. In some embodiments, the authentication server 30 is provided outside the information processing system 1 and used. In some embodiments, the distribution destination 20 is outside the information processing system 1.

The distribution system 10 includes, for example, an information processing device 100 and a data management server 130. The information processing device 100 is a single information processing device that has a computer configuration. Alternatively, the information processing device 100 is a system that includes a plurality of information processing devices each of which has the computer configuration. The information processing device 100 appropriately converts distribution data (electronic data) such as image data or document data registered from a terminal device such as the information terminal 110 or the image forming apparatus 120 into a predetermined format to be distributed to the distribution destination 20.

The data management server 130 is a single information processing device that has the computer configuration. Alternatively, the data management server 130 is a system that includes a plurality of information processing devices each of which has the computer configuration. The data management server 130 functions as a data storage unit that stores the distribution data to be distributed to the distribution destination 20 by the information processing device 100 and a distribution log 131 including bibliographic information of the distribution data. The bibliographic information of the distribution data may include various information such as information on a user who has registered the distribution data, a registration date and time, information on a registration terminal, properties of the distribution data, and text data representing document content of the distribution data.

The information terminal 110 is an information processing device used by a user, such as a personal computer (PC), a tablet terminal, or a smartphone, for example. The information terminal 110 is an example of a registration terminal that registers an electronic file such as document data generated by an application or image data captured by a camera in the distribution system 10 as the distribution data.

Examples of the image forming apparatus 120 include an electronic apparatus such as a multifunction peripheral (MFP) having a single housing with a scanning function, a copying function, a printing function, and a facsimile communication function, for example. The image forming apparatus 120 is another example of the registration terminal that registers in the distribution system 10 an electronic file such as image data read by scanning function as the distribution data. The registration terminal may be another electronic device or an information processing device that has a communication function and is used to register an electronic file such as image data in the information processing apparatus 100. For example, the registration terminal may be an interactive whiteboard (WB), which is a white board having an electronic whiteboard function for mutual communication, an industrial machine, an imaging device, a medical device, a network home appliance, a connected car, a mobile phone, a game machine, a Personal Digital Assistant (PDA), a digital camera, or a wearable terminal.

The distribution destination 20 is an example of an information processing device or a system to which the distribution system 10 distributes the distribution data. In the example of FIG. 1, the distribution destination 20 includes a linkage server 21 and the information terminal(s) 110. The linkage server 21 is a single information processing device that has the computer configuration. Alternatively, the linkage server 21 is a system that includes a plurality of information processing devices each of which has the computer configuration. The linkage server 21 is implemented by a storage server and stores a link file 22 distributed from the distribution system 10, for example. In the description of the present embodiment, the link file 22 is an electronic file including information (an example of reference information) of a link destination for using the distribution data provided by the distribution system 10.

The information terminal 110 of the distribution destination 20 is, for example, an information processing device such as a Personal Computer (PC), a tablet terminal, or a smartphone used by a user. The information terminal 110 is an example of a user terminal for using the distribution data distributed by the distribution system 10 by using the link file 22. The information terminal 110 in the distribution destination 20 may be a terminal device different from or same as the information terminal 110 in the distribution system 10.

The authentication server 30 is a single information processing device that has the computer configuration. Alternatively, the authentication server 30 is a system that includes a plurality of information processing devices each of which has the computer configuration.

The authentication server 30 authenticates terminal devices including the registration terminals in the distribution system 10 (for example, the information terminal 110 and the image forming apparatus 120) and the user terminals in distribution destinations (for example, the information terminal 110). In addition to or in alternative to the terminal devices, the authentication server 30 authenticates a user of the terminal devices. For example, the authentication server 30 executes authentication for the user of the information terminal 110 by an authentication method such as a Security Assertion Markup Language (SAML) method or an open identification (ID) method. When the authentication is successful, the authentication server 30 issues an authentication code such as an assertion or a security token for the information terminal 110. The authentication code allows the information terminal 110 to skip an authentication process and log in to the distribution system 10, the linkage server 21, or the like.

Overview of Operation:

A description is given below of an overview of operation of the information processing system 1, with reference to FIG. 1. In the following description, a user who registers distribution data with the distribution system 10 using the registration terminal such as the information terminal 110 or the image forming apparatus 120 is referred to as a “registrant.” In addition, a user who uses the distribution data distributed by the distribution system 10 with the user terminal such as the information terminal 110 is referred to as a “user.”

In FIG. 1, a registrant uses the registration terminal (such as the information terminal 110 or the image forming apparatus 120) to register the distribution data such as image data or document data with the information processing device 100 (step S1). For example, the registrant registers with the information processing device 100 image data obtained by scanning a document with the image forming apparatus 120 as the distribution data. For example, the registrant registers with the information processing device 100 document data generated by the information terminal 110 as the distribution data.

In response to the registration, the information processing device 100 performs predetermined processing on the distribution data as appropriate (step S2). For example, when the distribution system 10 is a system that provides the distribution data in a format of Portable Document Format (PDF), the information processing device 100 converts the registered electronic data into the distribution data in the format of PDF. For example, when the distribution system 10 is a system that provides the distribution data in a format of Joint Photographic Experts Group (JPEG), the information processing device 100 converts the registered electronic data into the distribution data in the format of JPEG.

In step S3, the information processing device 100 stores, in the data management server 130, the distribution log 131 including the distribution data on which the predetermined processing is performed and the bibliographic information of the distribution data. At this time, for example, a data analysis module 102 implemented by a program executed by the information processing device 100 analyzes the distribution log 131 stored in the data management server 130 and generates security information to be set to the distribution data (security information of the distribution data) (step S4). The security information includes, for example, information indicating a user range that is a range of users permitted to use the distribution data (for example, “COMPANY INTERNAL USE,” “DEPARTMENT INTERNAL USE,” etc.) or information indicating a permitted use application that indicates how the distribution data is used (for example, to browse, to download, etc.).

Subsequently, the information processing device 100 distributes the link file 22, which is for using the distribution data stored in the data management server 130, to the distribution destination 20 (step S5). For example, the information processing device 100 stores the link file 22 in the linkage server 21 of the distribution destination. The link file 22 includes, for example, path information for using the image data provided by the distribution system 10, a Uniform Resource Locator (URL), or the reference information such as a data ID for identifying the distribution data. In some embodiments, the processing of step S5 is performed before the processing of step S4, or is performed in parallel with the processing of step S4.

Accordingly, the distribution data distributed by the distribution system 10 is available by the users who use the user terminals (for example, the information terminals 110) in the distribution destination 20 by using the link file 22 (step S6). For example, the user uses the information terminal 110 to acquire the link file 22 stored in the linkage server 21, and requests for use of the distribution data stored in the data management server 130, by using the reference information included in the link file 22.

At this time, for example, a use monitoring module 101 implemented by a program executed by the information processing device 100 monitors the use of the image data by using the reference information included in the link file 22. The use monitoring module 101 permits or prohibits the use of the distribution data used by the user based on the security information of the distribution data generated by the data analysis module 102 (step S7). For example, when the user range, which is the range of users permitted to use the distribution data, is set in the security information of the distribution data, the use monitoring module 101 prohibits the use of the distribution data used by users who are not included in the user range. When the permitted use application, which indicates how the distribution data is available, is set in the security information of the distribution data, the use monitoring module 101 prohibits the use of distribution data in a way that is not included in the permitted use application.

In addition, the use monitoring module 101 stores use history corresponding to the use of the distribution data used by the user (use history of the distribution data)(step S8). For example, the user history stored by the use monitoring module 101 includes, for example, information such as identification information for identifying the distribution data accessed by using the reference information (hereinafter, referred to as a data ID), identification information for identifying the user (hereinafter, referred to as a user ID), a usage date and time, and a use application.

According to the above-described processing, the distribution system 10 sets the security information of the distribution data by analyzing the distribution data or the bibliographic information of the distribution data included in the distribution log 131 stored in the data management server 130, without depending on a user operation for the settings. Accordingly, the distribution system 10 according to the present embodiment may decrease setting erroneous security information to the distribution data occurring by performing an erroneous operation, such as a user operation of specifying wrong data.

The system configuration of the information processing system 1 illustrated in FIG. 1 is an example. In some embodiments, the function of the data management server 130 is included in the information processing device 100. In some embodiments, a server outside the distribution system 10, such as a cloud service, is used as the function of the data management server 130. In some embodiments, the data analysis module 102 is implemented by executing the program on a computer other than the information processing device 100. In some embodiments, the use monitoring module 101 may be implemented by executing a program on a computer other than the information processing device 100. The distribution destination 20 to which the link file 22 is distributed is not limited to the linkage server 21, and may be, for example, a terminal device such as the information terminal 110 or the image forming apparatus 120.

Hardware Configuration:

Hardware Configuration of Information Processing Device, Information Terminal, Data Management Server, Linkage Server, Authentication Server:

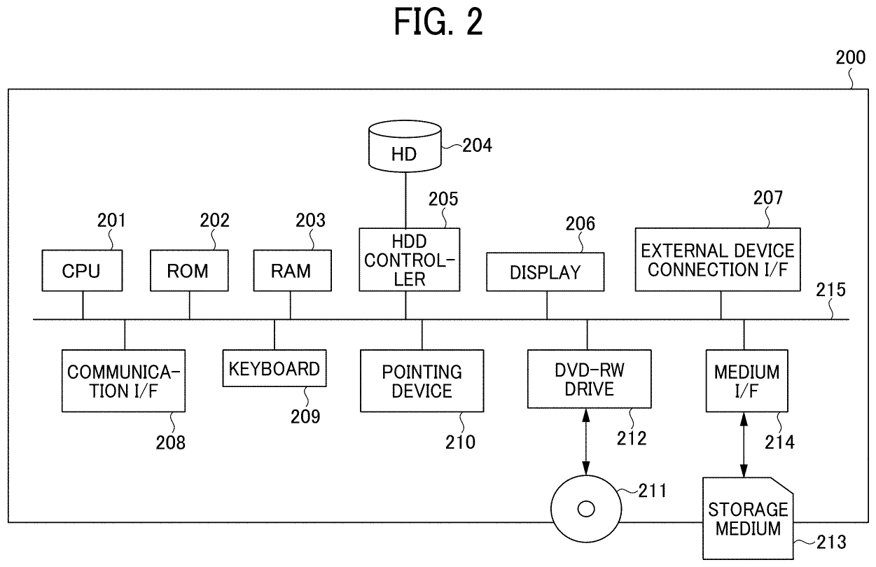

Each of the information processing device 100, the information terminal 110, the data management server 130, the linkage server 21, and the authentication server 30, has a hardware configuration of a computer 200 as illustrated in FIG. 2, for example. Alternatively, each of the information processing device 100, the data management server 130, the linkage server 21, and the authentication server 30 includes a plurality of computers 200.

FIG. 2 is a block diagram illustrating an example of the hardware configuration of the computer 200 according to the present embodiment. The computer 200 includes, for example, as illustrated in FIG. 2, a central processing unit (CPU) 201, a read only memory (ROM) 202, a random access memory (RAM) 203, a hard disk (HD) 204, a hard disk drive (HDD) controller 205, a display 206, an external device connection interface (I/F) 207, a communication I/F 208, a keyboard 209, a pointing device 210, a digital versatile disk rewritable (DVD-RW) drive 212, a medium I/F 214, and a bus line 215.

The CPU 201 controls entire operation of the computer 200. The ROM 202 stores programs used for driving the central processing unit (CPU) 201, such as an initial program loader (IPL). The RAM 203 is used as, for example, a work area for the CPU 201. The HD 204 stores, for example, programs such as an operating system (OS), an application, and a device driver, and various data. The HDD controller 205 controls, for example, reading and writing of various data from and to the HD 204 under control of the CPU 201.

The display 206 displays various information such as a cursor, a menu, a window, a character, or an image. The external device connection I/F 207 connects various external devices. The communication I/F 208 is an interface for connecting the computer 200 to a communication network. The keyboard 209 is an example of an input device provided with a plurality of keys for allowing a user to input characters, numerals, or various instructions. The pointing device 210 is an example of an input device that allows a user to select or execute a specific instruction, select processing to be executed, or move a cursor being displayed.

The DVD-RW drive 212 reads and writes various data from and to a DVD-RW 211, which is an example of a removable recording medium. The DVD-RW 211 is not limited to the DVD-RW and may be another removable recording medium. The medium I/F 214 controls reading or writing (storing) of data to a storage medium 213 such as a flash memory. The bus line 215 includes an address bus, a data bus, various control signals, and the like for electrically connecting each of above components.

Hardware Configuration of Image Forming Apparatus:

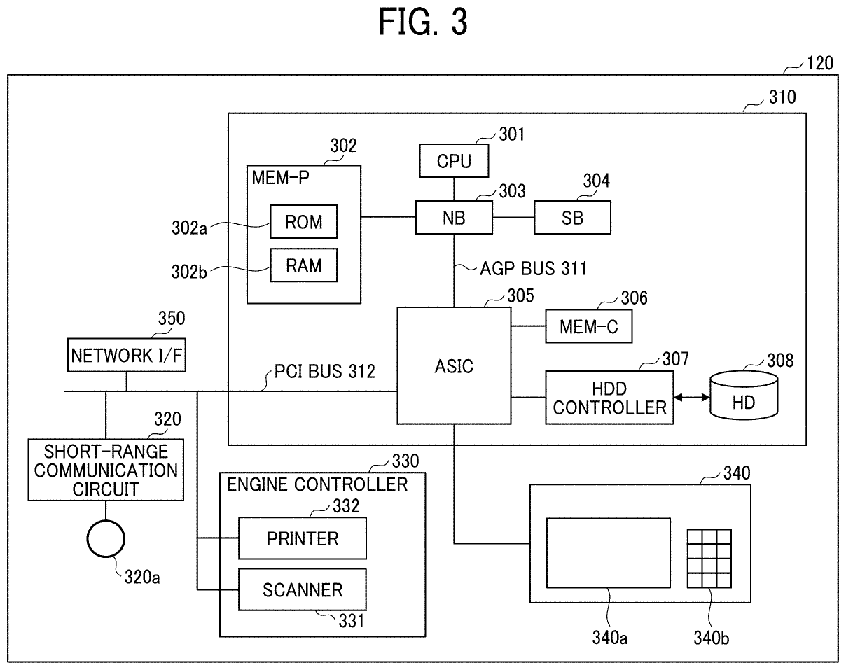

FIG. 3 is a block diagram illustrating an example of a hardware configuration of an image forming apparatus according to the present embodiment. As illustrated in FIG. 3, the image forming apparatus 120 includes, for example, a controller 310, a short-range communication circuit 320, an engine controller 330, a control panel 340, and a network I/F 350.

The controller 310 includes a CPU 301 as a main processor, a system memory (MEM-P) 302, a north bridge (NB) 303, a south bridge (SB) 304, an Application Specific Integrated Circuit (ASIC) 305, a local memory (MEM-C) 306, an HDD controller 307, and an HD 308 as a storage unit. The NB 303 and the ASIC 305 are connected through an Accelerated Graphics Port (AGP) bus 311.

The CPU 301 is a controller that controls overall operation of the image forming apparatus 120. The NB 303 connects the CPU 301 with the MEM-P 302, the SB 304, and the AGP bus 311. The NB 303 includes a memory controller for controlling reading or writing of various data with respect to the MEM-P 302, a Peripheral Component Interconnect (PCI) master, and an AGP target.

The MEM-P 302 includes a ROM 302a as a memory that stores program and data for implementing various functions of the controller 310. The MEM-P 302 further includes a RAM 302b as a memory that deploys the program and data, or as a drawing memory that stores drawing data for printing. The program stored in the RAM 302b may be stored in any computer-readable storage medium, such as a compact disc-read only memory (CD-ROM), compact disc-recordable (CD-R), or digital versatile disc (DVD), in a file format installable or executable by the computer for distribution.

The SB 304 connects the NB 303 with a PCI device or a peripheral device. The ASIC 305 is an integrated circuit (IC) dedicated to an image processing use, and connects the AGP bus 311, a PCI bus 312, the HDD controller 307, and the MEM-C 306. The ASIC 305 includes a PCI target, an AGP master, an arbiter (ARB) as a central processor of the ASIC 305, a memory controller for controlling the MEM-C 306, a plurality of direct memory access controllers (DMACs) capable of converting coordinates of image data with a hardware logic, and a PCI unit that transfers data between a scanner 331 and a printer 332 through the PCI bus 312. The ASIC 305 may be connected to a Universal Serial Bus (USB) interface or an Institute of Electrical and Electronics Engineers (IEEE) 1394 interface.

The MEM-C 306 is a local memory used as a buffer for image data to be copied or a code buffer. The HD 308 stores various image data, font data for printing, and form data. The HDD controller 307 controls reading from or writing to the CPU 301 according to the control of the HD 308. The AGP bus 311 is a bus interface for a graphics accelerator card, which has been proposed to accelerate graphics processing. Through directly accessing the MEM-P 302 by high-throughput, speed of the graphics accelerator card is improved.

The short-range communication circuit 320 performs various short-range wireless communication using an antenna 320a or the like for the short-range communication circuit. The engine control 330 includes, for example, a scanner 331 and a printer 332. The scanner 331 is a reading device that scans a document. The printer 332 is a printing device that performs printing based on print data. The scanner 331 and the printer 332 each performs various image processing, such as error diffusion or gamma conversion.

The control panel 340 includes a display panel 340a and an operation panel 340b. The display panel 340a is implemented by, for example, a touch panel that displays current settings or a selection screen and receives a user input. The operation panel 340b includes a numeric keypad that receives set values of various image forming parameters such as image density parameter and a start key that accepts an instruction for starting copying. The controller 310 controls overall operation of the image forming apparatus 120. For example, the controller 310 controls drawing, communication, or inputs with respect to the control panel 340.

In response to an instruction to select a specific application through the control panel 340, for example, using a mode switch key, the image forming apparatus 120 selectively performs a document box function, a copy function, a print function, and a facsimile function. The document box mode is selected when the document box function is selected, the copy mode is selected when the copy function is selected, the printer mode is selected when the printer function is selected, and the facsimile mode is selected when the facsimile mode is selected.

The network I/F 350 is an interface that transmits or receives data through a communication network. The short-range communication circuit 320 and the network I/F 350 are electrically connected to the ASIC 305 through the PCI bus 312.

Functional Configuration:

A description is given below of a functional configuration of the information processing system 1 according to the present embodiment.

Functional Configuration of Distribution System:

The distribution system 10 includes, for example, a reception unit 401, a processing unit 442, a data management unit 403, a data storage unit 404, a generating unit 405, a reference information providing unit 406, a use monitoring unit 407, a processing execution unit 408, and a storage unit 409 each of which is implemented by executing a predetermined program on one or more computers 200. At least a part of the above functional units may be implemented by hardware.

The reception unit 401 is implemented by, for example, a program executed by the CPU 201 of the information processing device 100, and receives registration of the distribution data (electronic data) such as the document information or the image data from the registration terminal such as the information terminal 110 or the image forming apparatus 120.

The processing unit 402 is implemented by, for example, a program executed by the CPU 201 of the information processing device 100, and performs the predetermined processing on the distribution data received by the reception unit 401 as appropriate. For example, when the distribution system 10 is a system that provides the distribution data in the format of PDF, the processing unit 402 converts the distribution data received by the reception unit 401 into the distribution data in the format of PDF. When the distribution system 10 is a system that provides the image data in the format of JPEG, the processing unit 402 converts the distribution data received by the reception unit 401 into the distribution data in the format of JPEG. However, the present disclosure is not limited thereto, and the processing unit 402 may perform various processing such as converting the distribution data into image data of a predetermined size, converting the distribution data from colored one into monochrome one, setting a copy-forgery-inhibited pattern, and adding a time stamp.

The processing unit 402 according to the present embodiment may perform character recognition processing such as Optical Character Recognition/Reader (OCR) processing on the distribution data and add the extracted text data to the bibliographic information of the distribution data.

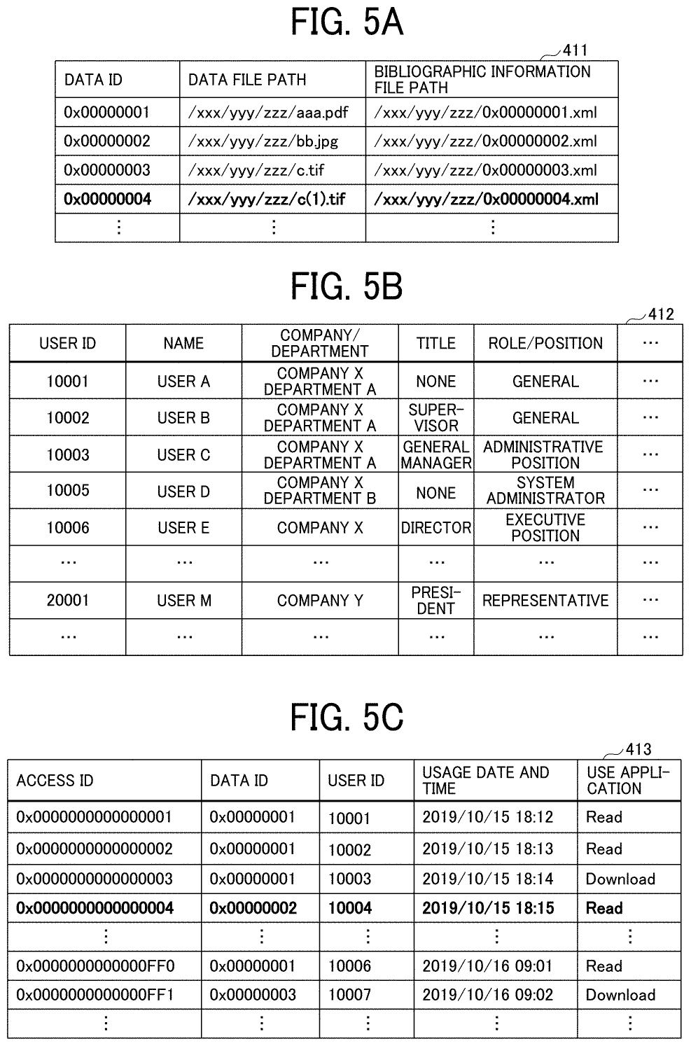

The data management unit 403 is implemented by, for example, a program executed by the CPU 201 of the information processing device 100, and stores and manages the distribution data to be distributed by the distribution system 10 and the distribution log 131 including the bibliographic information of the distribution data in the data storage unit 404. For example, the data management unit 403 stores the distribution log 131 including the distribution data and the bibliographic information of the distribution data in the data storage unit 404, and stores the distribution data and the bibliographic information included in the stored distribution log 131 as management information 411 as illustrated in FIG. 5A.

FIG. 5A is a table illustrating an example of the management information 411 according to the present embodiment. In the example of FIG. 5A, the management information 411 includes records each of which includes data items of “DATA ID,” “DATA FILE PATH,” and “BIBLIOGRAPHIC INFORMATION FILE PATH.” The “DATA ID” is identification information for identifying the distribution data (or the distribution log 131) stored in the data storage unit 404. The “DATA FILE PATH” is information indicating a storage location, or a storage destination, where the distribution data is stored. The “BIBLIOGRAPHIC INFORMATION FILE PATH” is information indicating a storage location, or a storage destination, in which the bibliographic information of the distribution data is stored.

The data storage unit 404 is implemented by, for example, the data management server 130, a program executed by the CPU 201 of the information processing device 100, the HD 204, or the HDD controller 205. The data storage unit 404 stores the distribution data registered in the distribution system 10 and the distribution log 131 including the bibliographic information of the distribution data under control of the data management unit 403.

The generating unit 405 is implemented by, for example, a program (such as the data analysis module 102 illustrated in FIG. 1) executed by the CPU 201 of the information processing device 100. The generating unit 405 analyzes the distribution data registered in the distribution system 10 or the bibliographic information of the distribution data, and generates the security information of the distribution data.

For example, when the bibliographic information of the distribution data includes text data indicating the document content of the distribution data, the generating unit 405 extracts the text data indicating the document content of the distribution data from the bibliographic information of the distribution data. Alternatively, when the bibliographic information of the distribution data does not include the text data indicating the document content of the distribution data, the generating unit 405 executes the character recognition processing such as the OCR processing on the distribution data to extract the text data indicating the document content of the distribution data.

In addition, the generating unit 405 determines the user range, which is the range of users permitted to use the distribution data, (for example, “COMPANY INTERNAL USE,” “DEPARTMENT INTERNAL USE,” etc.) based on a keyword extracted from the text data indicating the document content of the distribution data. The user range, which is the range of users permitted to use the distribution data, may be an attribute of user (for example, a position or a role of user).

In addition, the generating unit 405 extracts the properties of the distribution data from the bibliographic information of the distribution data, and determines the permitted use application, which indicates how the distribution data is available (for example, to display, to download, to edit, or to delete), of the distribution data on the basis of the properties of the distribution data.

Through the above-described processing, the generating unit 405 generates the security information that includes, for example, the user range, which is the range of users permitted to use the distribution data, and the use application, which indicates how the distribution data is available, of distribution data. The generating unit 405 may execute the above-described processing when the data management unit 403 stores the distribution data in the data storage unit 404 (an example of a predetermined time), or may execute the above-described processing at a predetermined time interval (another example of a predetermined time), for example.

The reference information providing unit 406 is implemented by, for example, a program executed by the CPU 201 of the information processing device 100. The reference information providing unit 406 generates the link file 22 for using the distribution data stored in the data storage unit 404 by the data management unit 403, and provides the generated link file 22 to the distribution destination 20. For example, the reference information providing unit 406 generates the link file 22 including the data ID, the data file path, or the like included in the management information 411 illustrated in FIG. 5A, and distributes the generated link file 22 to the linkage server 21 of the distribution destination 20. Each of the data ID, the data file path, or the like included in the link file 22 is an example of the reference information used for using the distribution data.

The use monitoring unit 407 is implemented by, for example, a program (such as the use monitoring module 101 illustrated in FIG. 1) executed by the CPU 201 of the information processing device 100. The use monitoring unit 407 monitors the use of the distribution data used by the user, and permits or prohibits the use of the distribution data used by the user based on the security information of the distribution data generated by the generating unit 405.

For example, the use monitoring unit 407 receives a request for the use of the distribution data used by the user who has been successfully authenticated in the authentication performed by the authentication server 30. In addition, the use monitoring unit 407 receives a request for the use of the distribution data used with the user terminal of the user who has been successfully authenticated in the authentication performed by the authentication server 30. Hereinafter, the request for the use of the distribution data may be referred to as a distribution data use request. When receiving the distribution data use request, the use monitoring unit 407 further determines whether to permit or prohibit the use of the distribution data used by the user based on the security information of the distribution data. For example, the use monitoring unit 407 determines whether the user is included in the user range, which is the range of users permitted to use the distribution data based on the security information of the distribution data and user information 412 as illustrated in FIG. 5B. The user information 412 is stored in advance in the storage unit 409.

FIG. 5B is a table illustrating an example of the user information 412 according to the present embodiment. In the example of FIG. 5B, the user information 412 includes records each of which includes data items of “USER ID,” “NAME,” “COMPANY/DEPARTMENT (AFFILIATION),” “TITLE,” AND “ROLE/POSITION.” The “USER ID” is identification information for identifying a user registered in advance in the distribution system 10. The “NAME” is information indicating, for example a name of a user. The “COMPANY/DEPARTMENT (AFFILIATION)” is information indicating a group such as a department to which a user belongs. The “TITLE” is information indicating a job title of a user. The “ROLE/POSITION” is information indicating a role or a position of a user. Each of the “TITLE,” AND the “ROLE/POSITION” are examples of information indicating a role (group) of a user.

For example, in a case where the user range, which is the range of users permitted to use the distribution data and indicated in the security information, is “DEPARTMENT INTERNAL USE,” and a department to which the registrant of the distribution data belongs is different from a department to which the user of the distribution data belongs, the use monitoring unit 407 prohibits the use of the distribution data used by the user. In addition, for example, in a case where the permitted use application, which indicates how the distribution data is available and indicated in the security information is to “Display” and the distribution data use request from the user is to download the distribution data, the use monitoring unit 407 prohibits the use of the distribution data used by the user.

With respect to the above examples, the use monitoring unit 407 permits the use of the distribution data used by the user in a case where the department to which the registrant of the distribution data belongs is the same as the department to which the user belongs, and the distribution data use request from the user is to display the distribution data.

In addition, the use monitoring unit 407 stores and manages the use history of the distribution data using the reference information included in the link file 22 as history information 413 as illustrated in FIG. 5C.

FIG. 5C is a table illustrating an example of the history information 413 according to the present embodiment. In the example of FIG. 5C, the history information 413 includes records each of which includes data items of “ACCESS ID,” “DATA ID,” “USER ID,” “USAGE DATE AND TIME,” AND “USE APPLICATION.” The “ACCESS ID” is identification information for identifying access to the distribution data, and the identification information is added by the use monitoring unit 407. The “DATA ID” is identification information for identifying accessed distribution data, and corresponds to the “DATA ID” in FIG. 5A. The “USER ID” is identification information for identifying a user who has used the distribution data, and corresponds to the “USER ID” in FIG. 5B. The “USAGE DATE AND TIME” is information indicating a date and time when the use terminal or the user used the distribution data.

The “USE APPLICATION” is information indicating a use application of the distribution data. In the example of FIG. 5C, “Read” indicates that the use application of the distribution data is to browse (or to display), and “Download” indicates that the use application of the distribution data is to download.

The processing execution unit 408 is implemented by, for example, a program executed by the CPU 201 of the information processing device 100, and executes the predetermined processing on the distribution data used by using the reference information included in the link file 22.

As an example, the processing execution unit 408 executes processing for limiting the use of the distribution data, which is used by using the reference information. With respect to the processing for limiting the use of the distribution data, for example, processing for limiting use of image data may include prohibiting printing of the image data, prohibiting saving of the image data, prohibiting screen capturing of the image data, and setting an expiration date for the image data.

As another example, the processing execution unit 408 executes adding predetermined information to the distribution data to be used by using the reference information. For example, the processing execution unit 408 may execute adding information (a copy-forgery-inhibited pattern, an electronic watermark, or the like) for specifying the user who has used the distribution data, the use date and time, the user terminal, or the like to the distribution data used by using the link file 22.

The storage unit 409 is implemented by, for example, a program executed by the CPU 201 of the information processing device 100, the HD 204, or the HDD controller 205. The storage unit 409 stores various information and data such as the management information 411, the user information 412, the history information 413, and the security information 414.

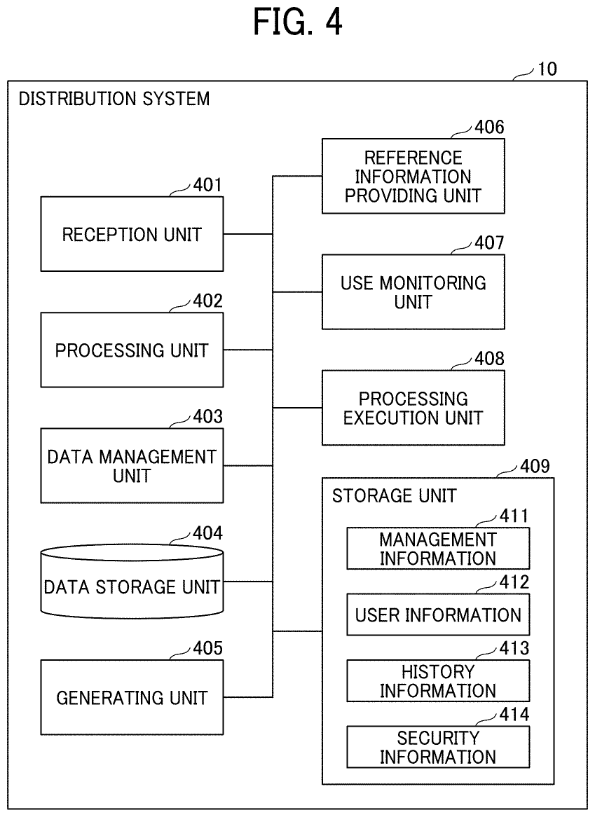

The functional configuration of the distribution system 10 illustrated in FIG. 4 is an example. For example, the data storage unit 404 may be implemented by storage server outside the distribution system 10, such as a cloud system.

Functional Configuration of Registration Terminal:

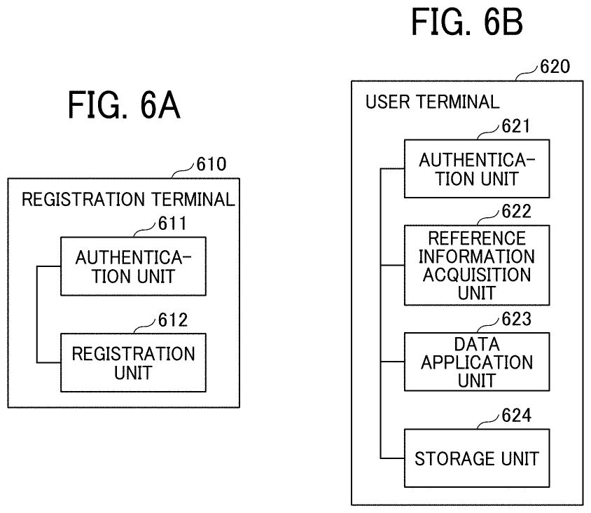

FIG. 6A is a block diagram illustrating an example of a functional configuration of a registration terminal 610 according to the present embodiment. In the following description, a terminal device such as each of the information terminal 110 and the image forming apparatus 120 that registers the distribution data such as the document data or the image data with the distribution system 10 is referred to as the registration terminal 610.

The registration terminal 610 implements, for example, an authentication unit 611 and a registration unit 612 by executing a predetermined program with the CPU 201 illustrated in FIG. 2 (or the CPU 301 of FIG. 3), for example. At least a part of the above described functional units may be implemented by hardware.

The authentication unit 611 uses the authentication server 30 to authenticate the registrant who uses the registration terminal 610 (or the registration terminal 610). For example, the authentication unit 611 requests the authentication server 30 to authenticate the registrant by an authentication method such as SAML or open ID. When the authentication for the registrant is successful, the authentication unit 611 acquires an authentication code (assertion, security token, or the like) issued by the authentication server 30.

The registration unit 612 registers the distribution data (electronic data) such as the document data and the image data generated with the registration terminal 610 with the information processing device 100. For example, the registration unit 612 transmits, to the distribution system 10, a distribution data registration request including the distribution data to be registered and the authentication code acquired by the authentication unit 611.

Functional Configuration of User Terminal:

FIG. 6B is a block diagram illustrating an example of a functional configuration of a user terminal 620 according to the present embodiment. In the following description, a terminal device such as the information terminal 110 that uses the distribution data provided by the distribution system 10 is referred to as the user terminal 620.

The user terminal 620 includes an authentication unit 621, a reference information acquisition unit 622, a data application unit 623, and a storage unit 624 each of which is implemented by a predetermined program executed with the CPU 201 illustrated FIG. 2, for example. At least a part of the above-described functional units may be implemented by hardware.

The authentication unit 621 uses the authentication server 30 to authenticate the user who uses the user terminal 620 (or the user terminal 620). For example, the authentication unit 621 requests the authentication server 30 to authenticate the user by an authentication method such as SAML or open ID. When the authentication for the user is successful, the authentication unit 621 acquires an authentication code (assertion, security token, or the like) issued by the authentication server 30.

The reference information acquisition unit 622 acquires the link file 22 (an example of the reference information) provided by the distribution system 10. For example, the reference information acquisition unit 622 acquires the link file 22 stored in the linkage server 21 by the distribution system 10. The reference information acquisition unit 622 may acquire the link file 22 provided by the distribution system 10 without the linkage server 21.

The data application unit 623 uses the distribution data managed by the data management unit 403 of the distribution system 10 by using the reference information included in the link file 22 acquired by the reference information acquisition unit 622. For example, the data application unit 623 transmits, to the distribution system 10, the distribution data use request including the reference information such as a data ID or a data file path included in the link file 22 acquired by the reference information acquisition unit 622 and the authentication code acquired by the authentication unit 621. In addition, the data application unit 623 uses the distribution data that is provided from the distribution system 10 in response to the distribution data use request. For example, the data application unit 623 browses (displays) or downloads (stores) the distribution data, which is provided from the distribution system 10.

The storage unit 624 is implemented by, for example, a program executed by the CPU 201 illustrated FIG. 2, the HD 204, or the HDD controller 205, and stores various information such as the link file 22.

Processes:

A description is given below of a process flow of data distribution method with respect to the distribution data according to the present embodiment.

Distribution Data Registration Process 1:

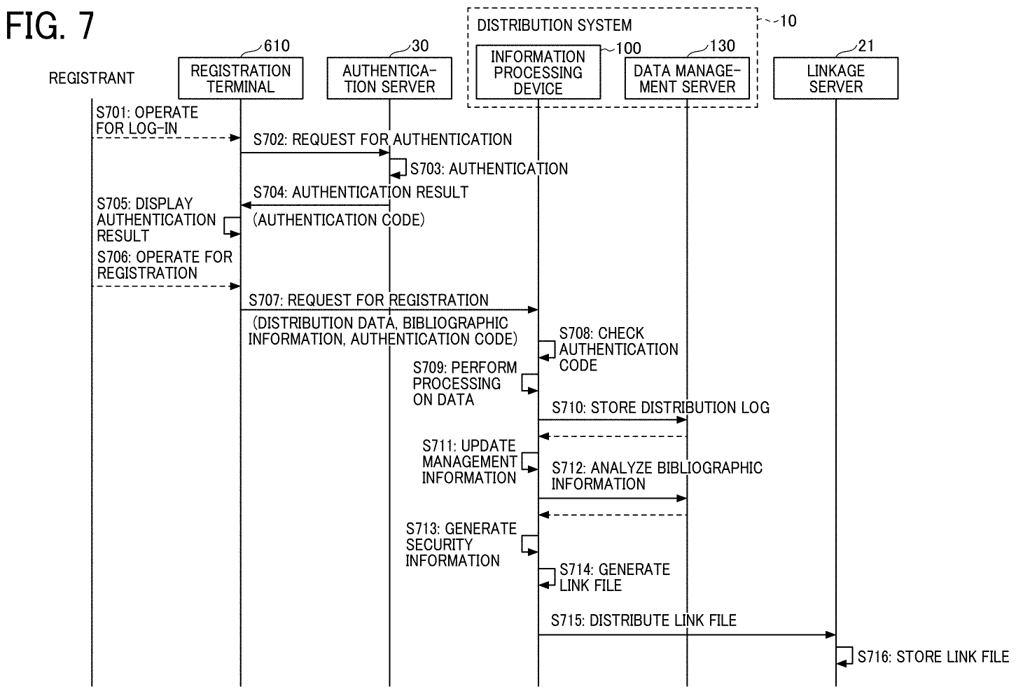

FIG. 7 is a sequence diagram illustrating an example of a process of registration of the distribution data (distribution data registration process) according to the present embodiment. In the example of distribution data registration process of FIG. 7, the registrant registers the distribution data with the distribution system 10 by using the registration terminal 610. In the example, the information processing device 100 includes the reception unit 401, the processing unit 402, the data management unit 403, the generating unit 405, the reference information providing unit 406, the use monitoring unit 407, the processing execution unit 408, and the storage unit 409 in the functional configuration of the distribution system 10 illustrated in FIG. 4. In addition, the data management server 130 includes the data storage unit 404 of the functional configuration of the distribution system 10 illustrated in FIG. 4.

In step S701, when the registrant performs a log-in operation on the registration terminal 610, for example, authentication processing of steps S702 to S705 is executed.

In step S702, the authentication unit 611 of the registration terminal 610 transmits an authentication request for requesting the authentication of the registrant to the authentication server 30. The authentication request includes, for example, a user ID for identifying the registrant and authentication information such as a password, biometric information, or an electronic certificate.

In steps S703 and S704, the authentication server 30 executes the authentication processing for authenticating the registrant (or the registration terminal 610), and transmits an authentication result to the registration terminal 610. In the example, the authentication of the registrant (or the registration terminal 610) is successful and, for example, an authentication code for using the information processing system 1 such as an assertion or a security token is transmitted to the registration terminal 610.

In step S705, the authentication unit 611 of the registration terminal 610 displays an authentication result indicating that the authentication has succeeded on a display unit such as the display 206.

When the registrant performs a registration operation of the distribution data with the registration terminal 610 in step S706, distribution data registration processing of steps S707 to S716 is executed.

In step S707, the registration unit 612 of the registration terminal 610 transmits, to the distribution system 10, a distribution data registration request including the distribution data to be registered and the authentication code acquired by the authentication unit 611.

In step S708, the reception unit 401 of the information processing device 100 checks the authentication code included in the distribution data registration request. For example, the reception unit 401 inquires of the authentication server 30 whether the authentication code included in the distribution data registration request is a valid authentication code. When the authentication code included in the distribution data registration request is a valid authentication code, the information processing system 1 executes the processing subsequent to step S709. On the other hand, when the authentication code included in the distribution data registration request is not a valid authentication code, the information processing system 1 cancels the execution of the processing subsequent to step S709.

In step S709, the processing unit 402 of the information processing device 100 processes the electronic information included in the distribution data registration request into distribution information in a predetermined format as appropriate.

In step S710, the data management unit 403 of the information processing device 100 stores the distribution log 131 in the data storage unit 404 of the data management server 130. The distribution log 131 includes, for example, the distribution data processed by the processing unit 402 or the distribution data included in the distribution data registration request, and the bibliographic information of the distribution data.

In step S711, the data management unit 403 of the information processing device 100 updates the management information 411 as illustrated in FIG. 6A, for example. For example, the data management unit 403 registers to the management information 411 the data ID, the data file path, and the bibliographic information file path, which are stored in association with the distribution data in the data storage unit 404 of the data management server 130.

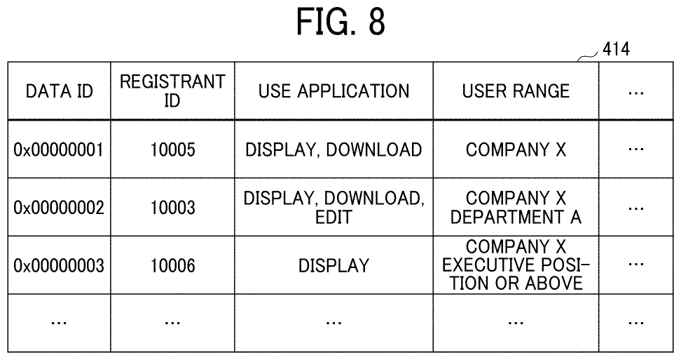

In steps S712 and S713, the generating unit 405 of the information processing device 100 analyzes the bibliographic information of the distribution data, which is stored in the data management server 130 by the data management unit 403, and generates the security information 414 of the distribution data as illustrated in FIG. 8, for example.

FIG. 8 is a table illustrating an example of the security information 414 according to the present embodiment. In the example of FIG. 8, the security information 414 includes records each of which includes data items of “DATA ID,” “REGISTRANT ID,” “USE APPLICATION,” and “USER RANGE.” The “DATA ID” is identification information for identifying the distribution data, and corresponds to the “DATA ID” of the management information 411 in FIG. 5A. The “REGISTRANT ID” is a user ID of a registrant who registered the distribution data. For example, the generating unit 405 acquires the “REGISTRANT ID” from the bibliographic information of the distribution data.

The “USE APPLICATION” is information indicating a permitted use application of the distribution data and the use application is permitted by the distribution system 10. For example, the generating unit 405 sets the “USE APPLICATION” based on the properties (for example, a file attribute) of the distribution data. Note that various use applications such as “limited to display” (download prohibited) and “editable” may be set as the “USE APPLICATION.”

The “USER RANGE” is information indicating a range of users permitted to use the distribution data by the distribution system 10. The “USER RANGE” is set based on a keyword extracted by the generating unit 405 from the text data (for example, text data of the entire document) indicating the document content of the distribution data. The text data indicating the document content of the distribution data is included in the bibliographic information of the distribution data, for example. For example, the text data may be included in the bibliographic information transmitted by the registration terminal 610 in step S707 of FIG. 7, or the text data extracted from the distribution information by the processing unit 402 in step S709 may be added to the bibliographic information.

In step S716, the reference information providing unit 406 of the information processing device 100 generates the link file 22 for use of the distribution data, which is stored in the data management server 130 by the data management unit 403. The link file 22 includes the reference information such as the data ID or the data file path of the distribution data stored in the data management server 130 by the data management unit 403.

In step S717, the reference information providing unit 406 of the information processing device 100 distributes the generated link file 22 to, for example, the linkage server 21 of the distribution destination 20.

In step S718, the linkage server 21 of the distribution destination 20 stores the link file 22 distributed from the information processing device 100.

According to the above-described processing, for example, as illustrated in FIG. 1, the link file 22 is stored in the linkage server 21 of the distribution destination, and the link file 22 is available via the user terminal 620 such as the information terminal 110.

Distribution Data Registration Process 2:

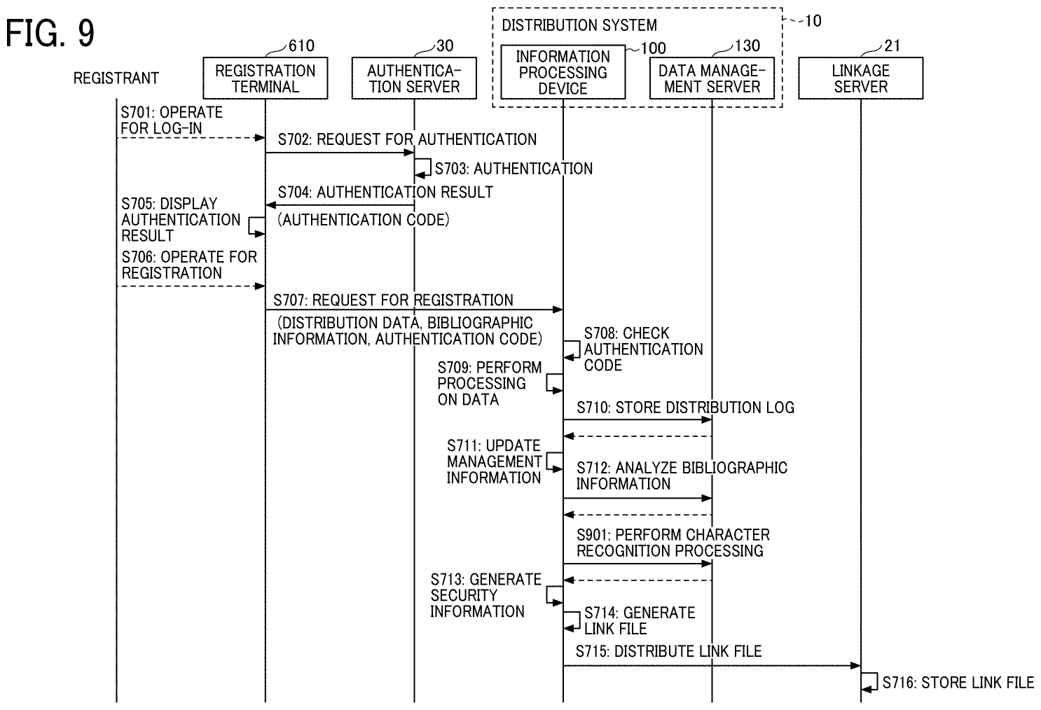

FIG. 9 is a sequence diagram illustrating another example of the process of registration of the distribution data (distribution data registration process) according to the present embodiment. In the example of distribution data registration process of FIG. 9, the text data indicating the document content of the distribution data is not included in the bibliographic information of the distribution data. The processing of steps S701 to S712 and the processing of S713 to S716 illustrated in FIG. 9 are the same as these of the distribution data registration process illustrated in FIG. 7, and differences from the process described with reference to FIG. 7 is mainly described below.

In step S712, the bibliographic information of the distribution data is analyzed, and when the analyzation indicates that the bibliographic information does not include the text data indicating the document content of the distribution data, the generating unit 405 of the information processing device 100 executes processing of step S901.

In step S901, the generating unit 405 executes the character recognition processing such as the OCR on the distribution data, which is stored in the data management server 130 by the data management unit 403, and acquires the text data indicating the document content of the distribution data (for example, the text data of the entire document). With this processing, the distribution system 10 performs the distribution data registration process that is substantially same as the distribution data registration process of FIG. 7 even when the bibliographic information of the distribution data does not include the text data indicating the document content of the distribution data.

Process for Using Distribution Data:

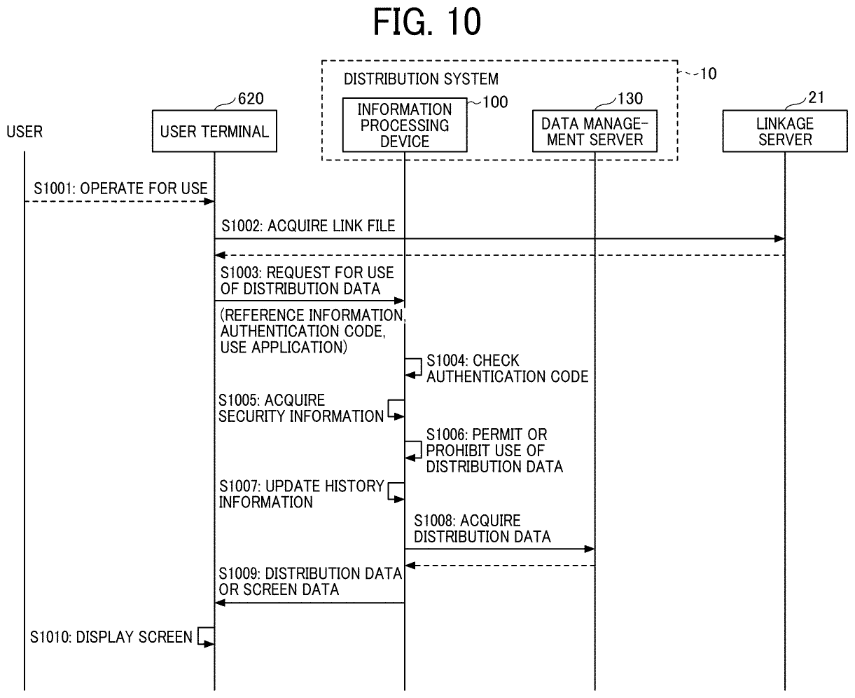

FIG. 10 is a sequence diagram illustrating an example of a process of using the distribution data according to the present embodiment. In the process of FIG. 10, the user uses the distribution data distributed by the distribution system 10 with the user terminal 620.

At the start of the process illustrated in FIG. 10, it is assumed that the authentication unit 621 of the user terminal 620 has executed the authentication processing of steps S701 to S705 of FIG. 7, for example, and acquires the authentication code for using the distribution system 10.

In step S1001, when the user performs an operation on the user terminal 620 for the use of the distribution data, the information processing system 1 executes a process for using the distribution data as illustrated in steps S1002 to S1010, for example.

In step S1002, the reference information acquisition unit 622 of the user terminal 620 acquires the link file 22 stored in the linkage server 21.

In step S1003, the data application unit 623 of the user terminal 620 transmits a distribution data use request to the distribution system 10. The distribution data use request includes, for example, the reference information such as the data ID or the data file path of the distribution data included in the link file 22, the authentication code acquired by the authentication unit 621, and the information indicating a use application (for example, to display or to download) of the distribution data.

In step S1004, the use monitoring unit 407 of the information processing device 100 checks the authentication code included in the distribution data use request. For example, the use monitoring unit 407 inquires of the authentication server 30 whether the authentication code included in the distribution data use request is a valid authentication code. When the authentication code included in the distribution data use request is a valid authentication code, the information processing system 1 executes the processing subsequent to step S1005. On the other hand, when the authentication code included in the distribution data use request is not a valid authentication code, the information processing system 1 cancels the execution of the processing subsequent to step S1005.

In step S1005, the use monitoring unit 407 of the information processing device 100 acquires the security information corresponding to the requested distribution data from the storage unit 409, for example. In step S1006, the use monitoring unit 407 determines whether to permit or prohibit the use of the distribution data used by the user based on the acquired security information.

For example, it is assumed that the acquired security information is the security information corresponding to the data-ID “0x00000001” included in the security information 414 illustrated in FIG. 8. In this case, the use monitoring unit 407 prohibits the use of the distribution data in response to the distribution data use request in which the use application of the distribution data is to edit or to delete, based on the acquired security information including the use application indicating limited to “Read.” In addition, the use monitoring unit 407 prohibits the use of the distribution data in response to the distribution data use request from other than the employees belonging to the company X, based on the acquired security information including the user range indicating “COMPANY X.” Whether the user of the user terminal 620 that has transmitted the distribution data use request belongs to the company X may be checked by, for example, acquiring the user ID of the user when checking the authentication code and comparing the user ID with the user information 412 as illustrated in FIG. 5B. With respect to the above examples, the use monitoring unit 407 permits the use of the distribution data in a case where the distribution data use request in which the use application of the distribution data is to display or to download and the distribution data use request is requested by the user belonging to the company X.

When the use monitoring unit 407 permits the use of the distribution data in response to the distribution data use request, the information processing system 1 executes the processing subsequent to step S1007. On the other hand, when the use monitoring unit 407 prohibits the use of the distribution data in response to the distribution data use request, the information processing system 1 cancels the processing subsequent to step S1007.

In step S1007, the use monitoring unit 407 of the information processing device 100 updates the history information 413 as illustrated in FIG. 5C, for example. For example, the use monitoring unit 407 newly assigns an access ID, and registers information including the data ID, the user ID of the user, the usage date and time, and the use application included in the distribution data use request as the history information 413 in association with the newly generated access ID.

In step S1008, the use monitoring unit 407 of the information processing device 100 acquires the requested distribution data from the data management server 130. In step S1009, the use monitoring unit 407 of the information processing device 100 transmits to the user terminal 620 the distribution data acquired from the data management server 130 or a display screen for displaying the content of the distribution data.

In step S1010, the data application unit 623 of the user terminal 620 displays a display screen based on the distribution data transmitted from the information processing device 100 or the display screen transmitted from the information processing device 100 on a display unit such as the display 206.

Process Performed by Use Monitoring Unit:

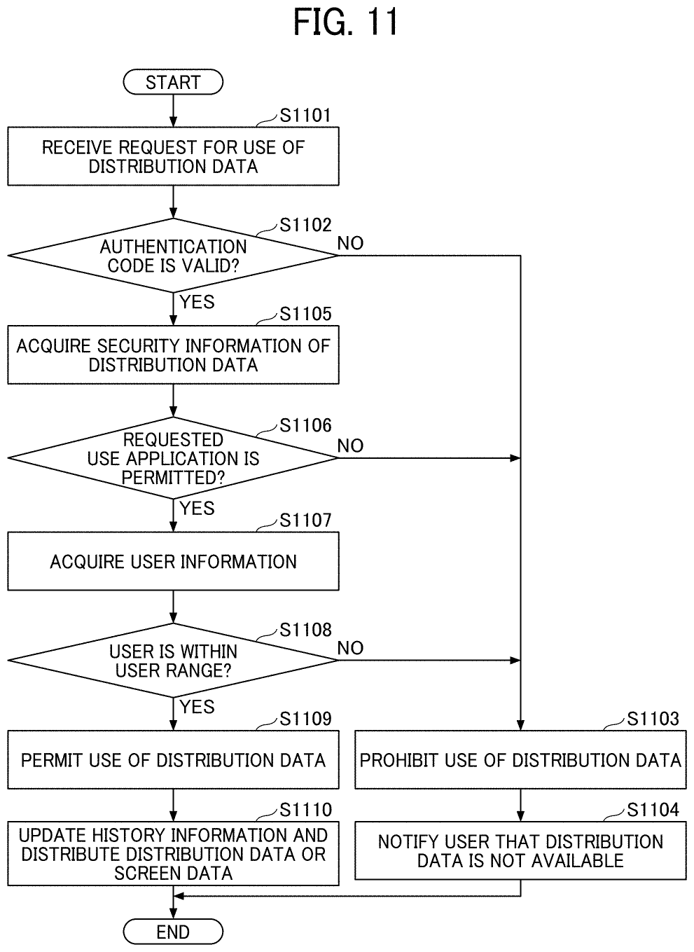

FIG. 11 is a flowchart illustrating an example of a process performed by a use monitoring unit according to the present embodiment. The process illustrated in FIG. 11 is an example of the processing of steps S1004 to S1006 of FIG. 10, performed by the use monitoring unit 407.

In step S1101, when the distribution data use request is received from the user terminal 620, the process performed by the use monitoring unit 407 proceeds to step S1102.

In step S1102, the use monitoring unit 407 determines whether the authentication code included in the use request is valid. For example, the use monitoring unit 407 inquires of the authentication server 30 whether the authentication code included in the distribution data use request is a valid authentication code. If the authentication code included in the distribution data use request is not valid, the process performed by the use monitoring unit 407 proceeds to step S1103. On the other hand, when the authentication code included in the distribution data use request is valid, the process performed by the use monitoring unit 407 proceeds to step S1105.

In step S1103, the use monitoring unit 407 prohibits (does not permit) the use of the distribution data used by the user. In step S1104, the use monitoring unit 407 notifies the user terminal 620, which is a request source, that the requested the distribution data is not available.

On the other hand, in step S1105, the use monitoring unit 407 acquires the security information of the distribution data requested by the distribution data use request from, for example, the security information 414 illustrated in FIG. 8.

In step S1106, the use monitoring unit 407 refers to the acquired security information to determine, based on the security information, whether a use application (for example, to display, to download, or to edit) requested in the distribution data use request is permitted.

When the requested use application is not permitted, the process performed by the use monitoring unit 407 proceeds to step S1103. On the other hand, when the requested use application is permitted, the process performed by the use monitoring unit 407 proceeds to step S1107.

In step S1107, the use monitoring unit 407 acquires, for example, the user information 412 illustrated in FIG. 5B from the storage unit 409. In step S1108, the use monitoring unit 407 uses the acquired user information 412 to determine whether the user requesting the use of the distribution data is included in the user range, which is the range of users permitted to use the distribution data and set in the security information. When the user is not included in (within) the user range, which is the range of users permitted to use the distribution data, the process performed by the use monitoring unit 407 proceeds to step S1103. On the other hand, when the user is not included in (not within) the user range, which is the range of users permitted to use the distribution data, the process performed by the use monitoring unit 407 proceeds to step S1109.

In step S1109, the use monitoring unit 407 permits the use of the distribution data requested in the distribution data use request. In step S1110, the use monitoring unit 407 updates the history information 413 and distributes (provides) the distribution data or a display screen of the distribution data to the user terminal 620.

Process Performed by Generating Unit:

### First Embodiment

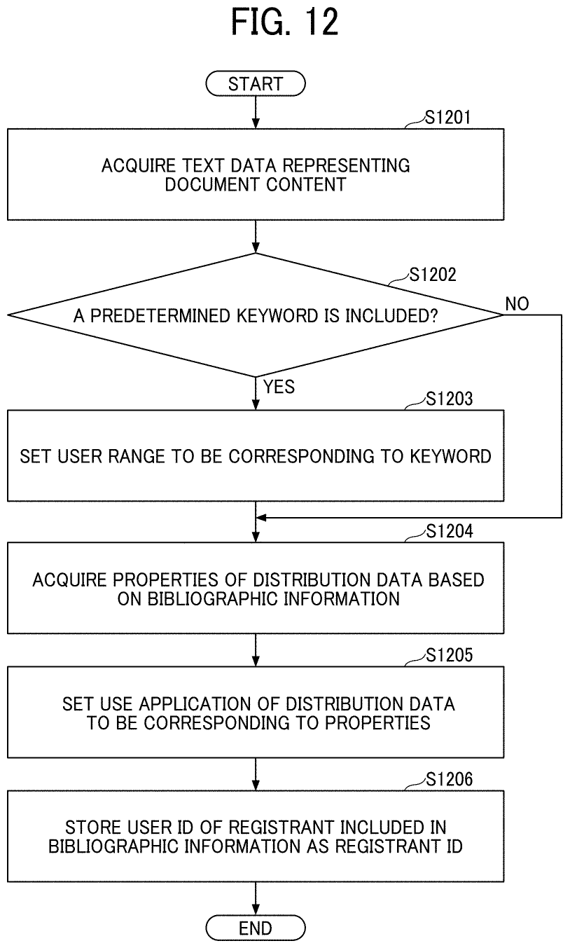

FIG. 12 is a flowchart illustrating an example of a process performed by a generating unit according to a first embodiment. The process illustrated in FIG. 12 is an example of the processing of steps S712 to S713 of FIG. 7, performed by the generating unit 405.

In step S1201, the generating unit 405 of the distribution system 10 acquires the text data indicating the document content of the distribution information from the distribution data or the bibliographic information of the distribution data, which is stored in the data management server 130 by the data management unit 403.

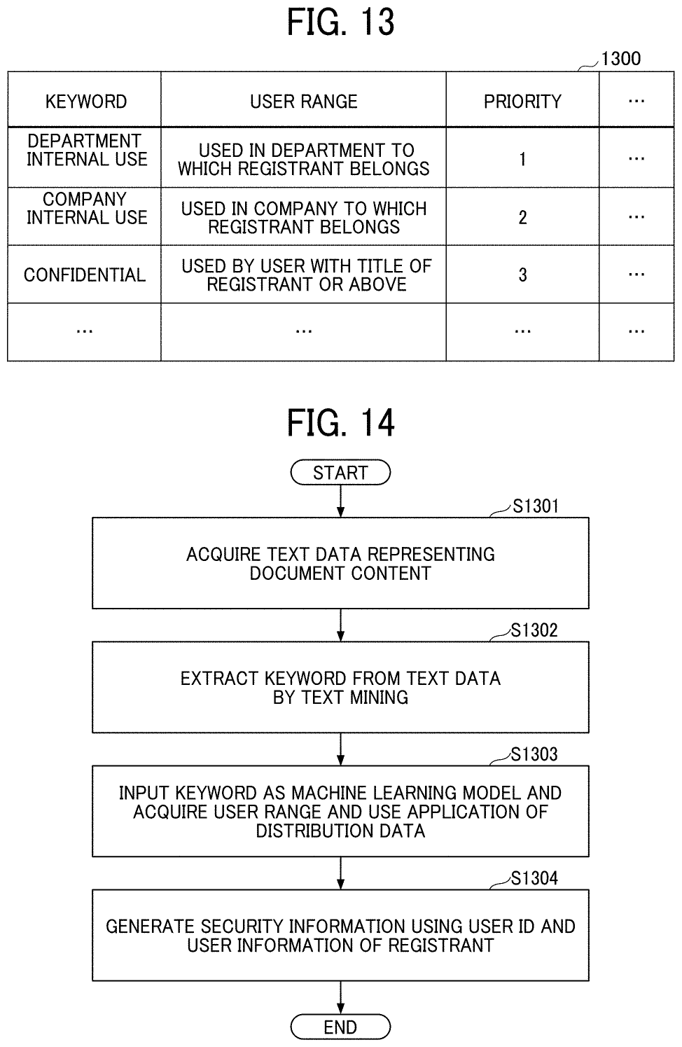

In step S1202, the generating unit 405 determines whether a predetermined keyword set in advance is included in the acquired text data. The predetermined keyword may be set by user. For example, the generating unit 405 stores, in the storage unit 409, association information 1300 in which correspondence between a keyword and a user range, which is the range of users permitted to use the distribution data, is stored in advance as illustrated in FIG. 13. In this case, the generating unit 405 determines whether the acquired text data includes any of the keywords stored in advance in the association information 1300.

FIG. 13 is a table illustrating an example of association information according to the first embodiment. In the example of FIG. 13, the association information 1300 includes records each of which includes data items of “KEYWORD,” “USER RANGE,” and “PRIORITY.” The “KEYWORD” corresponds to the above-described predetermined keyword set in advance. The “USER RANGE” is information indicating a range of users permitted to use the distribution data corresponding to each keyword. The “PRIORITY” is information indicating priority of each keyword. The smaller value is, the higher the priority becomes.

When the predetermined keyword is included in the acquired text data, the process performed by the generating unit 405 proceeds to step S1203. On the other hand, when the predetermined keyword is not included in the acquired text data, the process performed by the generating unit 405 proceeds to step S1204.

In step S1203, the generating unit 405 stores the user range corresponding to the predetermined keyword in the security information 414 as illustrated in FIG. 8, for example, in association with the data ID of the distribution data. For example, when the keyword of “COMPANY INTERNAL USE” is included in the acquired text data, the generating unit 405 acquires the user range corresponding to the keyword of “COMPANY INTERNAL USE” from the association information 1300 as illustrated in FIG. 13, and in this case, the user range is “USED IN COMPANY TO WHICH REGISTRANT BELONGS.” In addition, the generating unit 405 sets the “USER RANGE” to the security information 414 based on the acquired user range of “COMPANY TO WHICH REGISTRANT BELONGS” and the user information 412 as illustrated in FIG. 5B. When a plurality of keywords are included in the acquired text data, the generating unit 405 adopts the user range corresponding to a keyword having the highest priority among the keywords.

In step S1204, the generating unit 405 acquires properties (for example, a file attribute) of the distribution data from the bibliographic information of the distribution data. Further, in step S1205, the generating unit 405 stores the use application corresponding to the acquired properties in the security information 414 as illustrated in FIG. 8 in association with the data ID of the distribution data. For example, the generating unit 405 stores association information in which correspondence between properties of the distribution data and a use application of the distribution data is stored in advance in the storage unit 409. In addition, the generating unit 405 sets the use application of the distribution data corresponding to the properties of the distribution data in the security information of the distribution data by using the obtained properties of the distribution data and the association information in which the correspondence between the properties of the distribution data and the use application of the distribution data is stored in advance.

In step S1206, the generating unit 405 acquires the user ID of the registrant from the bibliographic information of the distribution data, and stores the acquired user ID of the registrant in the security information 414 as illustrated in FIG. 8, for example, in association with the data ID of the distribution data.

Through the above-described process, the generating unit 405 analyzes the distribution data, which is stored in the data management server 130 by the data management unit 403, or the bibliographic information of the distribution data and generates the security information of the distribution data. The generating unit 405 may execute the above-described process when the data management unit 403 stores the distribution data in the data management server 130 (an example of a predetermined time), or may execute the above-described process at a predetermined time interval (another example of a predetermined time), for example.

### Second Embodiment

In the first embodiment, the generating unit 405 sets the user range, which is the range of users permitted to use the distribution data, based on the predetermined correspondence between the predetermined keyword and the user range. However, the present disclosure is not limited thereto, and the generating unit 405 may generate the security information using a model that has been learned in advance by machine learning, for example.

In the present disclosure, the machine learning is defined as a technology that makes a computer to acquire human-like learning ability. In addition, the machine learning refers to a technology in which a computer autonomously generates an algorithm required for determination such as data identification from learning data loaded in advance and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning.

In the description of the present embodiment, as an example, a case in which the generating unit 405 sets the security information using a prediction model that has been learned in advance, with the predetermined keyword as learning data and the user range, which is the range of users permitted to use the distribution data, as teacher data.

FIG. 14 is a flowchart illustrating an example of a process performed by a generating unit according to a second embodiment. The process illustrated in FIG. 14 is an example of the processing of steps S712 to S713 of FIG. 7, performed by the generating unit 405.

In step S1301, the generating unit 405 of the distribution system 10 acquires the text data indicating the document content of the distribution information from the distribution data, which is stored in the data management server 130 by the data management unit 403, or the bibliographic information of the distribution data.

In step S1302, the generating unit 405 extracts a keyword from the acquired text data by applying a known text mining technology, for example.

In step S1303, the generating unit 405 inputs the extracted keyword to the prediction model that has been learned in advance, and acquires the user range, which is the range of users permitted to use the distribution data, the use application of the distribution data and the like.

In step S1304, the generating unit 405 generates the security information 414 as illustrated in FIG. 8, for example, using the user ID of the registrant acquired from the bibliographic information of the distribution data, the user information 412, and the information acquired in step S1303.

The prediction model used in the above-described processing may be, for example, a model that has been learned by simple machine learning that relatively increases a security level of the keyword included in a large number of documents including the keyword of “COMPANY INTERNAL USE” or the like. Alternatively, the prediction model used in the above-described processing may be, for example, a model that has been learned by machine learning so as to relatively increase a security level of the keyword extracted from a document having an access history indicating being accessed by user having a position that is higher than a predetermined position.

As described above, according to the above-described embodiments, the distribution system 10 sets the security information of the distribution data by analyzing the distribution data, which is stored in the data storage unit 404, or the bibliographic information of the distribution data without depending on a user operation for the settings. Accordingly, in the distribution system 10 that distributes the distribution data, the burden on the user when performing security setting on the distribution data is reduced, and the risk of erroneous operation or erroneous designation by the user is reduced.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

The apparatuses or devices described in the above-described embodiments are merely examples of plural computing environments that implement the above-described embodiments disclosed herein. In some embodiments, information processing device 100 includes multiple computing devices, such as a server cluster. The multiple computing devices communicate with one another through any type of communication link including a network, shared memory, etc., and perform a process described in the embodiment. Similarly, the data management server 130 may include multiple computing devices configured to communicate with one another.

Furthermore, the information processing device 100 and the data management server 130 may be configured to share the processing steps, for example, the processes illustrated in FIG. 7, FIG. 9 to FIG. 12, and FIG. 14 in various combinations. For example, a process executed by a particular unit may be executed by the information processing device 100. Similarly, a function of a particular unit may be performed by the data management server 130. Each element of the information processing device 100 and the data management server 130 may be integrated into one server device or may be divided into a plurality of devices.

In a conventional technique, there is a risk of erroneous operation or erroneous designation made by a user in setting security to distribution data, since setting of security information of the distribution data is performed by the user who registers the distribution data.

A distribution system that distributes distribution data according to one of the embodiments of the disclosure reduces a risk of an erroneous operation or an erroneous designation made by a user in setting security to the distribution data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. A distribution system, comprising
circuitry configured to:
analyze distribution data registered with the distribution system and bibliographic information of the distribution data at a predetermined time;
generate security information of the distribution data;
monitor use of the distribution data; and
determine whether to permit the use of the distribution data based on the security information of the distribution data.

2. The distribution system of claim 1, wherein
the circuitry further
provides reference information of the distribution data, the reference information being used in using the distribution data, and
monitors the use of the distribution data using the reference information.

3. The distribution system of claim 1, wherein
the bibliographic information of the distribution data includes text data indicating document content of the distribution data, and
the circuitry generates the security information based on a keyword obtained from the text data.

4. The distribution system of claim 1, wherein
the circuitry
analyzes the distribution data to obtain text data indicating document content of the distribution data, and
generates the security information based on a keyword obtained from the text data.

5. The distribution system of claim 1, wherein
the bibliographic information of the distribution data includes information on a registrant who has registered the distribution data, and
the circuitry generates the security information based on the information on the registrant.

6. The distribution system of claim 1, wherein
the bibliographic information of the distribution data includes properties of the distribution data, and
the circuitry generates the security information based on the properties of the distribution data.

7. The distribution system of claim 1, wherein
the security information includes information on a user range indicating a range of users permitted to use the distribution data.

8. The distribution system of claim 1, wherein
the security information includes information on a use application of the distribution data.

9. A distribution method, comprising:
analyzing distribution data registered with a distribution system and bibliographic information of the distribution data at a predetermined time;
generating security information based on the distribution data;
monitoring use of the distribution data; and
determining whether to permit the use of the distribution data used by the user based on the security information.

10. A non-transitory recording medium storing a plurality of instructions which,
when executed by one or more processors, cause the processors to perform a method, the method comprising:
analyzing distribution data registered with a distribution system and bibliographic information of the distribution data at a predetermined time;
generating security information based on the distribution data;
monitoring use of the distribution data; and
determining whether to permit the use of the distribution data used by the user based on the security information.
